(19) United States
(12) Patent Application Publication
(10) Pub. No.: US 2026/0240356 A1
(43) Pub. Date: Aug. 20, 2026

(54) BEVERAGE EXTRACTION SYSTEM

(71) Applicant: SOCIÉTÉ DES PRODUITS NESTLÉ S.A., Vevey (CH)

(72) Inventors: Chiara PAVAN, Vullierens (CH); Federica SORDO, Crissier (CH); Audrey Virginie MURPHY, Cossonay (CH)

(21) Appl. No.: 19/161,005

(22) PCT Filed: Mar. 15, 2024
(86) PCT No.: PCT/EP2024/056913

§ 371 Date: Aug. 29, 2025

(30) Foreign Application Priority Data
Mar. 20, 2023 (EP) 23162921.3
May 9, 2023 (EP) 23172183.8

(51) Int. Cl. A47J 31/36; A23F 5/26; B65D 85/804

(52) U.S. Cl. CPC A47J 31/3628; A23F 5/262; B65D 85/8043

(57) ABSTRACT

The invention concerns a system comprising an extraction device of a beverage preparation machine and a capsule, wherein—the capsule comprises a capsule body and a delivery wall forming a chamber, and—the extraction device comprises upstream and downstream capsule enclosing parts relatively movable between an open position for inserting and/or ejecting the capsule and a closed position for forming an extraction chamber enclosing the capsule during extraction, the downstream part comprising a extraction plate with engaging means in the form of pyramidal elements for opening the delivery wall of the capsule, wherein the delivery wall of the capsule is made of biodegradable materials and comprises in a layered manner at least a carrier layer adapted to be opened under the effect of rising pressure of the fluid being injected into the capsule, and an adhesive layer provided on the side of the carrier layer that is oriented towards the chamber for joining the delivery wall and the capsule body, and wherein pyramidal elements of the downstream part and the delivery wall of the capsule are designed so that—in a first step, the delivery wall interacts with the pyramidal elements and assumes an imprint of the pyramidal elements on its surface facing the pyramidal elements without visible piercing of the delivery wall,—in a second step, upon contact of the fluid injected in the capsule with the surface of the delivery wall facing the chamber of the capsule, permeable openings appear in the structure of the delivery wall through cavities in the structure of one or more of the layers of the delivery wall, and—during a third step, the formed beverage is drained from the capsule and contacts the extraction plate. Preferably, the capsule of the system of the invention is compostable and made of cellulose-based material, preferably molded-pulp cellulose-based material. The invention also relates to the use of a capsule in the system of the invention.

### FIELD OF THE INVENTION

The present invention relates to the field of preparation of beverages with a system including a single-serve container comprising a beverage ingredient and a machine that has an extraction chamber in which the container can be inserted and extracted.

### BACKGROUND OF THE INVENTION

Systems for the preparation of a beverage comprise a beverage preparation machine and a capsule. The capsule comprises a single serving of a beverage forming precursor material, e.g. ground coffee or tea. The beverage preparation machine is arranged to execute a beverage preparation process on the capsule, typically by the exposure of pressurized, heated water to said precursor material. As part of this preparation process, the capsule is guided through the machine by a series of complex interactions to load, process and eject the capsule, by various mechanisms of the machine and principally a flange portion of the capsule. Processing of the capsule in this manner causes the at least partial extraction of the precursor material from the capsule as the beverage.

Single serve containers for this type of automatic preparation of beverages encompass various formats of containers that can be relatively soft or flexible, such as capsules or pods, and made of any material, recyclable or non-recyclable, biodegradable or non-biodegradable, such as aluminium, plastic, filter paper.

This configuration of beverage preparation machine has increased popularity due to enhanced user convenience compared to conventional beverage preparation machines (e.g. compared to a manually operated Moka pot/stove-top espresso maker). In this context, the Nespresso® system has become extremely popular.

Such system, known as Nespresso® original system, and related capsules are for example disclosed in one or more of EP0512468A1, EP 0512470A1, EP1646305A1 or EP1165398A1. In these references, constructional, manufacturing and/or (beverage) extraction details of such aluminium capsules and/or closing members are also disclosed.

In particular, EP0512468A1 discloses such a capsule, preferably an aluminium capsule, to be used in such systems. The capsule is intended to be inserted into an extraction device, in which it can be pierced and injected with a fluid. The capsule is then opened against a supporting part of the device comprising raised elements under the effect of the pressure of the fluid entering the capsule.

Additionally, EP0512470A1 discloses a method for extracting a capsule under the pressure of a fluid passing through the bed of coffee contained in the capsule; the capsule comprising a membrane that retains pressure and tears in contact with raised elements of engaging means of the apparatus to let the liquid extract flow in the cup.

In more details, during the process of extraction, water is supplied in the capsule through the opened bottom wall which increases pressure inside the capsule and the capsule holder of the beverage machine, which comprising opening means, is designed for opening the lid by relative engagement with the lid under the effect of this rise in pressure of the injected liquid in the pod body chamber and inflation of the lid against the piercing arrangement of the opening means.

Due to the complex movement of the capsule through the machine and the exposure to pressurized, heated water, it is necessary to use rigid material such as aluminium or plastic. To date only an aluminium based capsule has been implemented with a high degree of reliability. Indeed, other materials have been found to be prone to sticking in the machine or cause other material related errors. It would be desirable to be able to implement the capsule with less of a materials restriction.

In order to propose an alternative to aluminium capsules, it is proposed today to use capsules made of biodegradable and/or compostable materials, in particular essentially made of cellulose, like molded cellulose pulp or paper.

These new materials lead to specific difficulties during the beverage preparation and the handling of the capsule in the extraction device. In particular, opening of the capsule and optimal extraction of roast and ground coffee may be a challenge.

Therefore, despite the effort already invested in the development of such compostable capsules further improvements are desirable and an object of the invention is to address the above existing problem.

### SUMMARY OF THE INVENTION

As used herein, the term “machine” or “device” may refer to an electrically operated device or machine that: can prepare, from a precursor material or ingredient, a beverage and/or foodstuff, or can prepare, from a pre-precursor material, a precursor material that can be subsequently prepared into a beverage and/or foodstuff. The machine may implement said preparation by one or more of the following processes: dilution; heating; pressurization; cooling; mixing; whisking; dissolution; soaking; steeping; extraction; conditioning; infusion; grinding, and other like process. The machine may be dimensioned for use on a work top, e.g. it may be less than 70 cm in length, width and height. As used herein, the term “prepare” in respect of a beverage and/or foodstuff may refer to the preparation of at least part of the beverage and/or foodstuff (e.g. a beverage is prepared by said machine in its entirety or part prepared to which the end-user may manually add extra fluid prior to consumption, including milk and/or water). As a preference in the present invention, the beverage extraction device is a Nespresso® Original Line extraction machine as described for example in one or more of EP0512468A1, EP0512470A1, EP1654966A1 or EP2142054A1 and as above discussed.

The Nespresso® Original Line system is disclosed in further details in connection with it brewing unit, piercing elements, brewing chamber (capsule cage) and capsule opening elements and process for example in WO2005/004683A1, in EP1816935A1 or in EP2098144A1.

As used herein, the term “container”, “capsule” or “cartridge” may refer to any configuration to contain the precursor material, e.g. as a single-serving, pre-portioned amount. The container may have a maximum capacity such that it can only contain a single serving of precursor material. The container may be single use, e.g. it is physically altered after a preparation process, which can include one or more of: perforation to supply fluid; for example a liquid like water, to the precursor material; perforation to supply the beverage/foodstuff from the container; opening by a user to extract the precursor material. The container may be configured for operation with a container processing unit of the machine, e.g. it may include a flange for alignment and directing the container through or arrangement on said unit. The container may include a rupturing portion, which is arranged to rupture when subject to a particular pressure to deliver the beverage/foodstuff. The container may have a membrane for closing the container. The container may have various forms, including one or more of: frustoconical; cylindrical; disk; hemispherical, and other like form. The container may be formed from various materials, such as metal or plastic or wood pulp based a combination thereof. As a preference in the present invention, the container is a compostable capsule, preferably made of cellulose and preferably made as a cellulose or wood pulp molded capsule. The material may be selected such that it is: food-safe; it can withstand the pressure and/or temperature of a preparation process. The container may be defined as a capsule, wherein a capsule may have an internal volume of 20-100 ml. The capsule includes a coffee capsule, e.g. a Nespresso® capsule (including a Classic/Original Line, Professional, or other capsule). As used herein, the term “system” or “beverage or foodstuff preparation system” may refer to the combination of any two or more of: the beverage or foodstuff preparation machine; the container; the server system, and the peripheral device.

As used herein, the term “beverage” may refer to any substance capable of being processed to a potable substance, which may be chilled or hot. The beverage may be one or more of: a solid; a liquid; a gel; a paste. The beverage may include one or a combination of: tea; coffee; hot chocolate; milk; cordial; vitamin composition; herbal tea/infusion; infused/flavoured water, and other substance. As used herein, the term “foodstuff” may refer to any substance capable of being processed to a nutriment for eating, which may be chilled or hot. The foodstuff may be one or more of: a solid; a liquid; a gel; a paste. The foodstuff may include yoghurt; mousse; parfait; soup; ice cream; sorbet; custard; smoothies; other substance. It will be appreciated that there is a degree of overlap between the definitions of a beverage and foodstuff, e.g. a beverage can also be a foodstuff and thus a machine that is said to prepare a beverage or foodstuff does not preclude the preparation of both. As a preference, the beverage is coffee including roast and ground coffee.

As used herein, the term “injection pressure” may be defined as the maximal pressure expressed in bar and measured at the injection point(s) in the capsule during extraction.

As used herein, the term “precursor material” or “ingredient” may refer to any material capable of being processed to form part or all of the beverage or foodstuff. The precursor material can be one or more of a: powder; crystalline; liquid; gel; solid, and other. Examples of a beverage forming precursor material include ground coffee; milk powder; tea leaves; coco powder; vitamin composition; herbs, e.g. for forming a herbal/infusion tea; a flavouring, and; other like material. Examples of a foodstuff forming precursor material include dried vegetables or stock as anhydrous soup powder; powdered milk; flour-based powders including custard; powdered yoghurt or ice-cream, and; other like material. A precursor material may also refer to any pre-precursor material capable of being processed to a precursor material as defined above, i.e. any precursor material that can subsequently be processed to a beverage and/or foodstuff. In an example, the pre-precursor material includes coffee beans which can be ground and/or heated (e.g. roasted) to the precursor material. As a preference, within the disclosed extraction process, the precursor material is roast and ground coffee.

As used herein, the term “fluid” (in respect of fluid supplied by a fluid conditioning system) may include one or more of a liquid, for example, water; milk; other.

As used therein, the expression “compostable material” may be understood as any material that can be broken down into environmentally innocuous products by (the action of) living things (such as microorganisms, e.g. bacteria, fungi or algae). This process could take place in an environment with the presence of oxygen (aerobic) and/or otherwise without presence of oxygen (anaerobic). This may be understood, for example, as meaning that composting can be carried out without reservation. In particular, at the end of a composting process there are no residues of the material, which may be problematic for the environment, or any non-biodegradable components. International standards, e.g. EU 13432 or US ASTM D6400, specify technical requirements and procedures for determining compostability of a material.

As used herein the term “wood pulp-based” may refer to the material or a portion of material forming the container which is one or more of: porous; fibrous; cellulosic; formed of cellulosic material; formed of natural cellulosic material; formed of reconstituted or regenerated cellulosic material; non-woven; is composed entirely of or is a composition of wood pulp, and is wet formed. A thickness of the wood-based material may be 0.25 mm to 0.75 mm or about 0.5 mm. The wood-based material may be 200-400 gsm.

As used herein the term “non-woven” may refer to a fabric-like material which is not woven or knitted. A non-woven material may be made from bonded together fibres. As used herein the term “porous” may refer to material configured with interstices to transmit water (or other liquid) therethrough. As used herein the term “fibrous” may refer to material comprised of fibres, which may be present in one or more of the material constituents. As used herein the term “cellulosic” or “cellulosic material” may refer to conventionally woody and/or non-woody materials, e. g. manila hemp, sisal, jute, bleached and unbleached soft wood and hard wood species. A cellulosic material may include a regenerated or reconstituted cellulose. As used herein the term “natural cellulosic material” may refer to conventionally woody materials, which are not regenerated. As used herein the term “reconstituted or regenerated cellulosic material” may refer natural cellulosic material subject to processing that comprises reconstitution or regeneration, examples include rayon and lyocell. As used herein the term “wood pulp” may refer to a lignocellulosic fibrous material, which may be prepared by mechanical or chemical separation of cellulose fibres from one or more of wood, fibre crops, paper or rags. As used herein the term “wet formed” may refer to a process of forming from an aqueous solution of fibres. The aqueous solution of fibres may be heated and pressed in a mould to set the material and remove water therefrom.

The capsule used in the system of the invention has the same design as a Nespresso® Original Line capsule and is fully made (capsule body and delivery wall) of compostable material, preferably of cellulose-based material, more preferably of pulp-molded cellulose-based material. The capsule is in the form of a frustoconical cup and has for example a diameter of 2-5 cm and an axial length of 2-4 cm.

In variant embodiments, which are not illustrated: the capsule may have other cross-section shapes, including square, other polygons, or elliptical; the closing member may be rigid or other non-membrane formation; the flange is alternatively connected to the upper surface of the closing member, e.g. by crimping; the sidewall is alternatively arranged, including with the reverse taper or is aligned to the depth direction, or is curved; the base is alternatively arranged, including with as flat or curved; the flange portion is connected to the storage portion rather than being integrally formed; the closing member is arranged as a storage portion, e.g. it comprises a cavity, and; the flange portion is omitted, e.g. the closing member connects directly to the storage portion.

There is provided a system comprising a beverage preparation machine and a capsule containing a beverage ingredient, preferably roast and ground coffee according to claim 1.

Specifically, the system comprises a beverage preparation machine and a capsule containing a beverage ingredient, preferably roast and ground coffee,

wherein the capsule comprises
a capsule body with a three-dimension shape comprising a sidewall delimiting a chamber for containing the beverage ingredient, and a rim portion delimiting an opening in the sidewall,
an injection wall for injecting a fluid in the chamber for preparing the beverage upon interaction of the fluid with the beverage ingredient, and
a delivery wall being connected to the capsule body to close the chamber, the delivery wall being made of biodegradable materials and comprising in a layered manner at least:
   a carrier layer adapted to be opened under the effect of rising pressure of the fluid being injected into the capsule, and
   an adhesive layer provided on the side of the carrier layer that is oriented towards the chamber for joining or bonding, preferably by sealing, more preferably by heat-sealing, the delivery wall onto the rim portion of the capsule body, and
      wherein the beverage preparation machine comprises an extraction device for extracting a beverage from the capsule, and said extraction device comprises:
upstream and downstream capsule enclosing parts relatively movable between an open position for inserting and/or ejecting the capsule and a closed position for forming an extraction chamber enclosing the capsule during extraction,
the upstream part bearing:
   an upstream piercing arrangement for opening the injection wall of the capsule, and
   a fluid injector,
the downstream part comprising an extraction plate engaging with the capsule, said extraction plate comprising pyramidal elements facing, in use, the delivery wall of the capsule, and
   wherein, during the preparation of a beverage, the extraction device is configured:
in a first step, to enclose the capsule between the upstream and downstream parts enclosing parts, and then,
in a second step, to introduce fluid inside the capsule through the fluid injector,

In the proposed invention, the pyramidal elements of the downstream part and the delivery wall of the capsule are designed so that
in a first step, the delivery wall interacts with the pyramidal elements and assumes an imprint of the pyramidal elements on its surface facing the pyramidal elements without visible piercing of the delivery wall,
in a second step, upon contact of the fluid injected in the capsule with the surface of the delivery wall facing the chamber of the capsule, permeable openings appear in the structure of the delivery wall through cavities in the structure of one or more of the layers of the delivery wall, and
during a third step, the formed beverage is drained from the capsule and contacts the extraction plate.

More specifically, the proposed system comprises a beverage preparation machine and a capsule containing a beverage ingredient, preferably roast and ground coffee. However, other ingredients may be considered, for example or eventually tea leaves or instant coffee or instant tea or chocolate or cacao or milk powder or dehydrated soup. In the preferred embodiment, the beverage ingredient is roasted and ground coffee.

The extraction device is configured for extracting the beverage ingredient contained in the capsule pod by supplying an extraction liquid such as water into the capsule. The device comprises upstream and downstream capsule enclosing parts relatively movable between an open position for inserting and/or ejecting such capsule and a closed position for forming an extraction chamber enclosing the capsule during beverage ingredient extraction.

Typically, the capsule can be inserted into the device from above under the effect of gravity. Ejection or removal of the capsule upon reopening of the enclosing parts may also be driven by gravity.

The upstream and downstream capsule enclosing parts are relatively movable between an open position for inserting and/or ejecting the pod and a closed position for forming an extraction chamber enclosing the capsule during extraction. In one particular embodiment. upstream and downstream pod enclosing parts are relatively translatable along a longitudinal axis.

The upstream part comprises an upstream piercing arrangement in the form of one or more piercers, for example needles or blades, for piercing the injection wall of the inserted capsule and at least one liquid injector for supplying liquid through the pierced injection wall of the capsule.

This upstream piercing arrangement can comprise piercers in the form of blades. These blades can be designed and positioned to pierce the injection wall of the capsule body when the upstream and downstream capsule enclosing parts are brought to the closed position. The fluid injector, such as a shower at the upstream part of the cage, can introduce the extracting fluid through the pre-pierced openings. The extracting fluid is preferably water.

In an alternative, this upstream piercing arrangement can comprise at least one hollow needle configured to pierce the injection wall of the pod body and the hollow needle(s) can comprise an internal axial channel for guiding the extracting fluid in the chamber of the capsule.

The downstream part or dispensing part defines a downstream extraction plate with engaging means arrangement for opening the delivery wall of the capsule when the extracting fluid is introduced inside the capsule. Usually, this extraction plate is designed for opening the delivery wall by relative engagement with the delivery wall under the effect of the rise in pressure of the injected fluid in the chamber of the capsule and inflation of the delivery against the piercing arrangement. This extraction plate comprises a plate, that is preferably rigid, and that comprises engaging elements like a plurality of relief and recessed elements such as spikes, that can present the shape of cones or pyramids on its surface turned to the second wall. In the present case, the engaging elements of the extraction plate comprise pyramidal elements. In addition, the plate comprises traversing holes to evacuate the beverage dispensed from the delivery wall to a tube or nozzle collecting and dispensing beverage to a drinking cup.

Usually, the shapes of the upstream and enclosing parts of the extraction device are defined according to the shape of the pod configured to be extracted therefrom.

The capsule here presented is made of compostable material. It comprises a three-dimension frustoconical shape capsule body with a sidewall delimiting a chamber for containing the beverage ingredient, and a rim portion delimiting an opening in the sidewall.

The capsule body is closed on one side by an injection wall for injecting a fluid in the chamber for preparing the beverage upon interaction of the fluid with the beverage ingredient, and on the other side by a delivery wall.

In the proposed solution, the injection wall is integral with the cup-body and the delivery wall is applied on the rim portion of the cup-body to close the capsule's chamber once the beverage ingredient has been filled inside the capsule.

In a proposed embodiment the delivery wall of the capsule is also made of biodegradable materials and presents a layered structure comprising at least a carrier layer and an adhesive layer.

The carrier layer is made of a material adapted to be opened under the effect of rising pressure of the fluid being injected into the capsule.

The adhesive layer is provided on the side of the carrier layer that is oriented towards the chamber for joining the delivery wall onto the rim portion of the capsule body, thereby closing the opening of the capsule body.

Preferably the delivery wall is sealed, preferably heat-sealed. However other ways of bonding the delivery wall to the rim of the capsule body may be proposed, for example by gluing.

The complete capsule is then in the form of a closed container in the form of a cup containing the beverage ingredient in its internal chamber which may lead to a more straightforward recovery of the organic material inside the capsule as well as of the capsule material itself.

Therein, the expression “biodegradable material” may be understood as any material that can be broken down into environmentally innocuous products by (the action of) living things (such as microorganisms, e.g. bacteria, fungi or algae). This process could take place in an environment with the presence of oxygen (aerobic) and/or otherwise without presence of oxygen (anaerobic). This may be understood, for example, as meaning that composting can be carried out without reservation. In particular, at the end of a composting process there are no residues of the material, which may be problematic for the environment, or any non-biodegradable components.

International standards, e.g. EU 13432 or US ASTM D6400, specify technical requirements and procedures for determining compostability of a material. Biodegradation can be tested following standards such as ISO 14855, ISO 17556 or ISO 14851. For example, one of the tests requires that—in order to be considered as being “industrially compostable”—at least 90% of the material in question is biologically degraded under controlled conditions in 6 months. Similar tests exist also to enable home composting certification.

Preferably and as part of the above disclosure, the extraction device is configured so that when the capsule enclosing parts are moving one to the other to enclose the capsule in the extraction chamber, at least a part of the extraction device pushes the capsule so that the delivery wall of the capsule faces the extraction plate of the downstream enclosing part.

Preferably, in the extraction device:
the upstream part defines a cage defines a cage designed to enclose the capsule body and bears an upstream piercing arrangement for opening the bottom wall of the capsule, and
the downstream part defines a capsule holder positioned transverse to the closing direction of the extraction device, said capsule holder comprising an extraction plate interacting with the delivery wall of the capsule during extraction of the beverage.

Hence, when a capsule is present in the extraction device, the capsule body is surrounded by the cage of the upstream part and the delivery wall extends along the downstream extraction plate comprising the engaging elements. The asymmetrical shape of the capsule presents the advantage of forcing the operator to position the capsule correctly inside the extraction device, precisely with the delivery wall in front of the downstream extraction plate and the engaging elements.

Generally, the extraction device can comprise an insertion section for inserting the capsule in the device. Generally, this section is positioned above the upstream and downstream capsule enclosing parts so that the capsule is inserted by gravity between these two parts. Depending on the shape of the capsule, this insertion section can be designed so that the user is urged to position the capsule with its delivery wall facing the engaging elements of the extraction plate.

Conventionally, this beverage machine comprises a liquid supply system connected to the upstream enclosing part. This liquid supply system can comprise:
a liquid supply such as a liquid tank,
pumping means to drive liquid from the liquid supply to the extraction device,
heating and/or cooling means to adapt the temperature of the liquid before it is introduced inside the pod.

The liquid that is used is usually water.

This beverage machine usually comprises an actuator, either manual or motorized, to actuate the movement of the enclosing parts of the extraction device Usually, this beverage machine comprises a control unit configured to control the supply of liquid to the extraction device and optionally the movement of the enclosing parts of the extraction device.

Usually, this system is configured to extract a coffee beverage from capsule comprising roast and ground coffee. In this process of preparation of a coffee beverage from the system, at least the following steps occur:
in a preliminary step, the capsule is inserted between the upstream and downstream capsule enclosing parts that are positioned in their opened position. This operation can be operated manually by the user or automatically by a motor of the beverage machine. Usually, the capsule is received in a capsule holder that keeps it between the two capsule enclosing parts which are hold far from each other in their opened positions.
then, in a first step, the upstream and/or downstream capsule enclosing parts are moved relatively one to the other to their closed position in order to form the extraction chamber that encloses the capsule for the coming extraction. At that step, the external surfaces of the injection wall and of the delivery wall of the capsule are in contact with or close to the surfaces of the upstream piercing arrangement and the extraction plate of downstream part. Usually, the upstream piercing arrangement, such as blades or hollow needle, pierces the injection wall of the capsule, except if this upstream piercing arrangement is retractable and can be moved in a further step.
then, in a second step, the extraction water is injected by the liquid injector through holes pierced inside the injection wall of the capsule by the upstream piercing arrangement. As water is being injected, it fills the chamber of the capsule. Pressure rises until the delivery wall of the capsule opens.

As previously presented, opening of the capsule, and delivering of the extracted beverage happen in a three-step process:
in the first step, the delivery wall interacts with the pyramidal elements. The delivery wall assumes the imprint of the pyramidal elements on its surface facing the pyramidal elements without visible piercing of the delivery wall.
in the second step, upon contact of the fluid injected in the capsule with the surface of the delivery wall facing the chamber of the capsule, permeable openings appear in the structure of the delivery wall through cavities in the structure of one or more of the layers of the delivery wall, and
during the third step, the formed beverage is drained from the capsule and contacts the extraction plate.

Surprisingly, with the proposed compostable capsule and presented compostable delivery wall, the interaction of the delivery wall and the pyramidal elements (due to pressure rinsing inside de capsule further to fluid injection), does not result in a rupture through tearing of the delivery wall with direct dispensing of the extracted beverage. Indeed, even if the delivery wall which inflates due to pressure rising engages with the pyramidal elements and assume the imprint and shape of the engaging elements of the extraction plate, there is no visible piercing or rupture of the delivery wall.

While the fluid under pressure fills the chamber of the capsule and pressure rises inside the capsule, the side of the delivery wall facing the chamber gets into contact with the fluid and permeable openings appear in the structure of the delivery wall.

The combination of layers of the delivery wall being stretched against the pyramidal elements and of the development of permeable cavities in some layers of the delivery wall, allows for a progressive opening of the capsule from which, in a third step, the extracted beverage is drained. After the extracted beverage is drained through the delivery wall, it contacts the extraction plate which participates in the formation of crema.

Specifically, in the system of the invention, the pyramidal elements of the extraction plate and the delivery wall of the capsule are designed so that, during the first step, the pyramidal elements do not pierce or tear the delivery wall during their relative engagement under the effect of the rise in pressure of the fluid injected in the capsule and inflation of the delivery wall against the pyramidal elements after the pressure inside the capsule reaches at least 6 bars, preferably at least 8 bars.

Preferably, the delivery wall of the capsule starts opening according to the above disclosed process after the pressure inside the capsule reaches at least 8 bars.

The carrier layer is made of a material that is compostable and/or has a defined, preferably closed fibre structure, such as fibre structures with at least 50% of weight corresponding to softwood pulp, cellulose fibres, paper or Polyhydroxyalkanoate (PHA), Polyhydroxybutyrate (PHB) and co-polymers, Polybutylenesuccinate (PBS/PBS-A), biopolyesters, Cellulose Acetate, starch, polyvinyl alcohol (PVOH), polymers where at least one of the monomer units is vinyl alcohol, compounds and/or laminates of the above mentioned materials.

As a preference, the carrier layer is made of paper-based material and has a grammage between 20 and 150 g/m2 , preferably between 30 and 100 g/m2 .

According to the needs, the characteristics of the carrier layer may be adjusted. For example, the tensile strength of the carrier layer can be improved by increasing the grammage of its material.

In accordance with the use of the capsule in a beverage preparation machine capable of feeding an amount of a fluid under pressure into the capsule, the carrier layer, preferably the material of the carrier layer, is configured such that it is resilient against a built-up pressure in the chamber between 1 and 20 bar, more preferred between 6 and 20 bar, most preferred between 10 and 18 bar.

In addition to the above, the delivery wall may comprise additional layers beside the carrier layer and the adhesive layer. These additional layers may be intercalated between the carrier layer, and the adhesive layers as needed and depending on their function.

The different layers are preferably made of different materials that preferably distinguish in at least one of their respective physical properties, such as tensile strength, ductility, elasticity, puncture resistance, density, porosity, and/or, if applicable, fibre structure and/or fibre orientation.

In particular and preferably, the delivery wall further comprises a filter layer for filtering out particles from the prepared beverage dispensed via the delivery wall, the filter layer being provided opposite to the chamber with respect to the carrier layer.

The filter layer is made of a compostable and/or non-woven material that is different from the carrier layer, such as wood or sugarcane pulp, cellulose fibres, rayon fibres, polybutylene succinate (PBS), poly(butylene succinate-co-butylene adipate) (PBS-A/PBSa), polyhydroxybutyrate (PHB) and/or Polylactic acid (PLA).

The filter layer has a grammage between 10 and 150 g/m2 , preferably between 20 and 100 g/m2. Having a filter layer with said grammage allows ensuring efficient filtering of any particle of the substance enclosed in the capsule chamber, for example roast and ground coffee.

In addition, the delivery wall further comprises a barrier layer for providing a preferably bidirectional barrier against moisture and/or gas, the barrier layer being preferably made of a different material than the filter layer and/or the carrier layer.

In the proposed delivery wall structure, the barrier layer is applied on the surface of the carrier layer facing the chamber of the capsule body, between the carrier layer and the adhesive layer The barrier layer (34) being made of a biodegradable and preferably compostable material, such as biopolymers, polyvinyl alcohol (PVOH), butenediol vinyl alcohol copolymer (BVOH) or polymers or co-polymers where at least one of the monomer units is vinyl alcohol, and compounds or laminates of the above-mentioned materials.

With the proposed delivery wall structure comprising the filter layer, the carrier layer and the barrier layer made from the previously proposed material, the Oxygen Transmission Rate (OTR) of the delivery wall is below 35 cc/m2/day, measured according to ASTM D3985/ISO 15105 methodology which allows increasing the shelf-life of the capsule by reducing oxidation of the beverage ingredient filled in the capsule.

Going into further details of the proposed system, the pyramidal elements of the extraction plate are designed so as to present truncated pyramidal top end portions so that the delivery wall of the capsule:
is stretched by the pyramidal elements, preferably by the truncated pyramidal top end portions of the pyramidal elements, in the first step of the beverage preparation, and
becomes permeable by formation of cavities without any tearing effect, in the second step of the beverage preparation.

Preferably, the cavities formed in the delivery wall of the capsule are mainly located proximate the top portions of the truncated pyramidal elements. This location corresponds to the parts where the delivery wall has been most stretched during its interaction with the pyramidal elements.

Preferably, most of the permeable cavities have a size ranging from 0.0001 mm 2 to 0.0040 mm2. The size of these openings as visible in the adhesive layer of the delivery wall is sufficient to ensure that be extracted beverage is drained outside the capsule so that the beverage is dispensed to the consumer.

The proposed delivery wall comprises a carrier layer, an adhesive layer, a filter layer and a barrier layer.

However, it is also conceivable that the delivery wall may comprise multiple different layers, which preferably may be made from different materials. This may lead to the advantageous effect that the combination of the two or more constituent materials with different physical or chemical properties produce a structure with characteristics different from each of the individual components. Thereby, the interface of the capsule to the outside can be tailored to the technical needs of the application. For example, by providing each of the layers with a different tensile strength, the pressure built up inside the capsule can be controlled and defined as required. Thereby, for example, the capsule can be designed to produce a beverage according to the specifications of its recipe. Moreover, by providing the two layers from materials with a different fibre configuration it is possible to tailor material characteristics relevant for the interaction of the delivery wall with the prepared beverage to the individual application, such as defining the filtering capabilities of the delivery wall. Also, the difference of orientation of the individual layers of the delivery wall may lead to different stresses in the layers, which can be taken into consideration with the above configuration by selecting different materials. For example, the material of one of the layers may break at a lower pressure than the material of another layer but the structure may be kept together by the combined resistance of each material, which may support each other under the effect of pressure.

One or more of the different layers of the delivery wall, namely the carrier layer, the filter layer, the adhesive layer and the barrier layer, is laminated with the other layers of the delivery wall. Thanks to the lamination of one or more of the mentioned layers, it is possible to produce a blank foil that is cut or punched to form the delivery wall. Depending on the dimension of the blank, several delivery walls may be formed from the same blank.

Additional layers may complete the delivery wall structure, for example a bonding layer for specific bonding of the carrier layer and filter layer and/or a protective layer applied between the barrier layer and the adhesive layer to protect the barrier layer and increase its efficiency. The invention is also related to the use of a capsule in a beverage preparation machine according to the system of the invention.

Within said use, the capsule comprises a capsule body with a three-dimension shape delimiting a chamber for containing a beverage ingredient, an injection wall and a delivery wall connected to the capsule body and closing the chamber, and the delivery wall comprises in a layered manner at least a carrier layer adapted to be opened under the effect of rising pressure of the fluid being injected into the capsule, and an adhesive layer provided on the side of the carrier layer that is oriented towards the chamber for joining the delivery wall (30) onto the capsule body.

The delivery wall of the capsule is designed so that when the upstream and downstream capsule enclosing parts of the beverage preparation machine, encloses the capsule and fluid is injected inside the capsule, the extraction plate of the downstream enclosing part interacts with the delivery wall without visible piercing of the delivery wall, and permeable openings appear in the structure of the delivery wall upon contact of the delivery wall's surface facing the chamber with the fluid injected in the capsule, draining the beverage outside the capsule. The above aspects of the invention may be combined in any suitable combination. Moreover, various features herein may be combined with one or more of the above aspects to provide combinations other than those specifically illustrated and described. Further objects and advantageous features of the invention will be apparent from the claims, from the detailed description, and annexed drawings.

### BRIEF DESCRIPTION OF THE DRAWINGS

Specific embodiments of the invention are now described further, by way of example, with reference to the following drawings in which:

FIG. 1A shows a schematic representation of a currently existing coffee extraction system which enables to prepare in a convenient way coffee beverages by extracting a capsule containing roast and ground coffee in a beverage preparation machine.

FIG. 1B shows a schematic representation of the system of FIG. 1A in which the beverage preparation machine is closed, and a capsule is being extracted in the beverage preparation machine.

FIG. 2 presents a graph showing the extraction curve of a series of (ristretto) aluminium capsules in a Nespresso® Inissia machine according to the prior art.

FIG. 3 shows an enlarged view of the delivery wall of an aluminium capsule extracted in the beverage preparation machine presented in FIGS. 1A and 1B and presenting an extraction curve according to FIG. 2.

FIG. 4 shows a schematic exploded view of a capsule used in the system according to an embodiment of the invention.

FIG. 5 shows an enlarged schematic cross-section of a section of the capsule's delivery wall used in the system according to an additional proposed embodiment.

FIG. 6A shows an enlarged view of the capsule's delivery wall of FIG. 5 viewed from the side of the filter layer, prior to the extraction of the capsule.

FIG. 6B shows an enlarged view of the capsule's delivery wall of FIG. 5 viewed from the side of the adhesive layer, prior to the extraction of the capsule.

FIG. 7 presents a graph showing the extraction curve of a series of pulp molded compostable capsules similar to the one of FIG. 4 comprising the delivery wall of FIG. 5, extracted in a Nespresso® Inissia machine.

FIG. 8 shows an enlarged view of the delivery wall viewed from the side of the filter layer after extraction of one of the capsules presented in the extraction curve of FIG. 7.

FIG. 9 shows a series of enlarged views at different scales of the delivery wall viewed from the side of the adhesive layer at two extraction time of one of the capsules presented in the curve of FIG. 7.

### DETAILED DESCRIPTION OF EXEMPLARY EMBODIMENTS

Before describing several embodiments of the system, it is to be understood that the system of the invention and the capsule and method that are disclosed are not limited to the details of construction or process steps set forth in the following description. It will be apparent to those skilled in the art having the benefit of the present disclosure that the system of the invention are capable of other embodiments and of being practiced or being carried out in various ways.

As used in this specification, the words “comprises”, “comprising”, and similar words, are not to be interpreted in an exclusive or exhaustive sense. In other words, they are intended to mean including, but not limited to.

Any reference to prior art documents in this specification is not to be considered as an admission that such prior art is widely known or forms part of the common general knowledge in the field.

The present disclosure may be better understood in view of the following explanations:

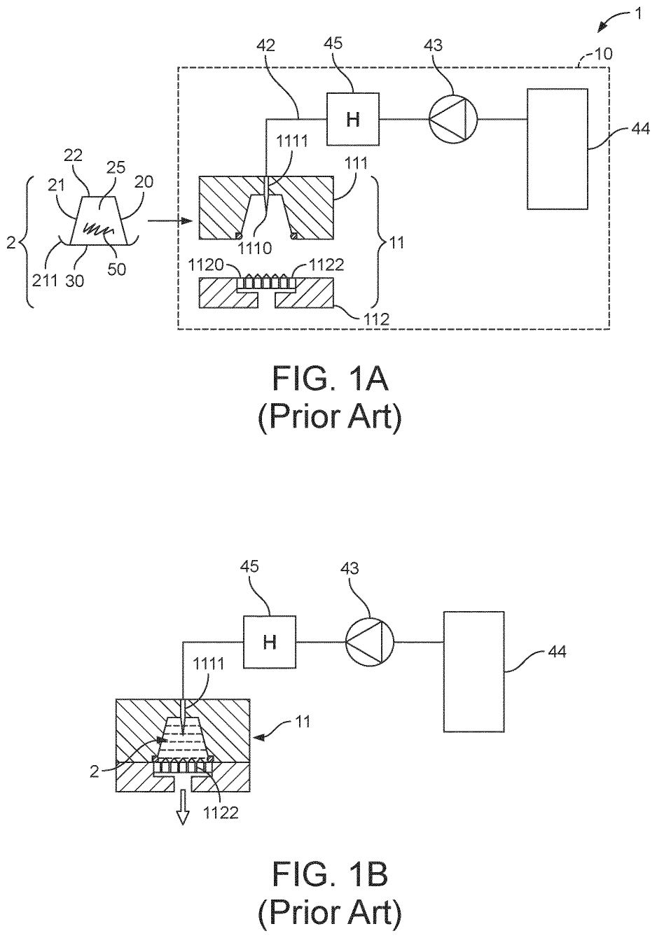

FIGS. 1A and 1B schematically illustrate an exemplary Nespresso® system used for extraction capsules to make beverages, for example coffee beverages. The extraction device 10 of the comprises an extraction module 11 (also disclosed as extraction chamber) for extracting coffee from a single capsule 2 at a time. The extraction module 11 comprises receiving means in the form of a downstream enclosing part also called support base or collector 112 and an upstream enclosing part also called injection part 111 comprising a fluid injector 1111. The support base 112 and the injection part 111 define an internal volume upon closing of the two parts to receive the capsule 2. In the support base 112 is located an extraction plate 1120 comprising engaging means arranged to engage with a delivery wall 30 of the capsule 2 when pressure of fluid is built inside the capsule further to injection of water under pressure inside the capsule 2. The engaging means of the extraction plate 1120 may comprise relief means such as a series of protruding elements in the form of pyramidal elements 1122. Alternatively, a network of elongated ribs or needles may be provided on the surface of the extraction plate.

The coffee extract is primarily filtered by the very narrow spacing produced between the pyramidal elements 1122 and the edges of the openings of the membrane. The extraction plate 1120 comprises a series of apertures (not shown) to drain the extract and eventually retain any solid coffee particles. The apertures may be provided through the plates in channels formed between the pyramidal elements 1122 or alternatively, be provided through the protruding elements themselves.

The device further comprises at least one fluid line 42 to which the fluid can be supplied in the capsule 2 via the fluid injector 1111. The fluid injector 1111 may comprise one or more needles or blades which create one or more passages for water to enter in the capsule. The fluid is supplied under pressure in the line by means of a pump 43. The pump may be an electromagnetic piston pump or any suitable water pumping mechanism such as a diaphragm pump or pressurized head systems. A reservoir of fluid 44 can be installed upstream the pump 43 to enable fluid to be supplied in sufficient amount for delivering fluid to extract more than a capsule. Preferably, the reservoir holds more than 750 ml of water so as to eliminate the inconvenience of repeatedly refilling the reservoir after a few extraction cycles. A heating system 45 can be installed along the line between the fluid reservoir 44 and the extraction module 11 to heat the fluid at a required temperature. The heater is configured to heat the water to a temperature of extraction of between 70 to 100° C. It can be a thermoblock or an instant heating device such as ceramic capsules. The reservoir could also be such as a boiler that can keep the fluid warm or hot. A control board with switches is also usually helpful to automatically start the extraction cycle. Different controls can be added such as temperature sensors, timers, flow meters, pressure sensors, vanes, probes and so on for controlling and monitoring the extraction operations.

In the present disclosure, the coffee capsule 2 has a body 20 in the form of a cup shaped body and generally comprises an injection wall 22 and a side wall 21, made of a material such as aluminium and/or plastic. The capsule also comprises a membrane also called delivery wall 30 made of aluminium closing the capsule on the opposite side of the injection wall 22.

When the extraction module 11 is closed around the capsule 2 and the capsule is positioned in the module, as shown in FIG. 1A, the delivery wall 30 is positioned adjacent or at a short distance from the engaging means in the form of pyramidal elements 1122 of the extraction please 1120. The delivery wall 30 of the capsule 2 is not opened until a certain opening pressure is built within the capsule by virtue of water coming in the capsule. The delivery wall 30 and engaging means are so arranged to not create an accidental opening before extraction begins. Therefore, as water is entering within the capsule pumped by the pump means 45, the internal pressure builds up inside the capsule which makes the delivery wall 30 to deform and press on the pyramidal elements 1122 of the extraction plate up to a point where it becomes pierced or torn open. The capsule 2 starts opening at a certain opening pressure (Popening), generally around 8 bars, but pressure usually continues increasing due to the compaction of the bed of ground coffee inside the capsule and also due to the pressure drop created by the narrow openings torn or pierced through the membrane of the capsule until a maximum pressure (Pmax) that is generally between 10 and 15 bars. Then, the pressure level usually flattens to a pressure of extraction also called equilibrium pressure (Peq), which is typically of several bars above the opening pressure and then drops when the pump is shut off. The overall pressure loss is usually the addition of the pressure loss created by the compacted coffee bed and the pressure loss created by the conjunction of the small openings through the delivery wall 30 and the extraction plate 1120 of the extraction device.

The pump has a fixed performance characteristic curve which means that it delivers a certain flow rate of water when downstream the pump has to overcome a certain pressure depending on the characteristics of the capsule (granulometry, membrane, etc.).

The “engaging means” represents an element of the extraction plate (or of the capsule in specific systems) having the function of engaging in or pressing against the membrane to provide a certain pressure loss that enables to delay the release of coffee out of the capsule. The engaging means can take various forms able to provide in conjunction with the delivery wall (membrane) a certain pressure loss such as a central needle or multiple needles or a plate with multiple protrusions like pyramidal elements and/or bumps, or a filter plate or other physical obstacles.

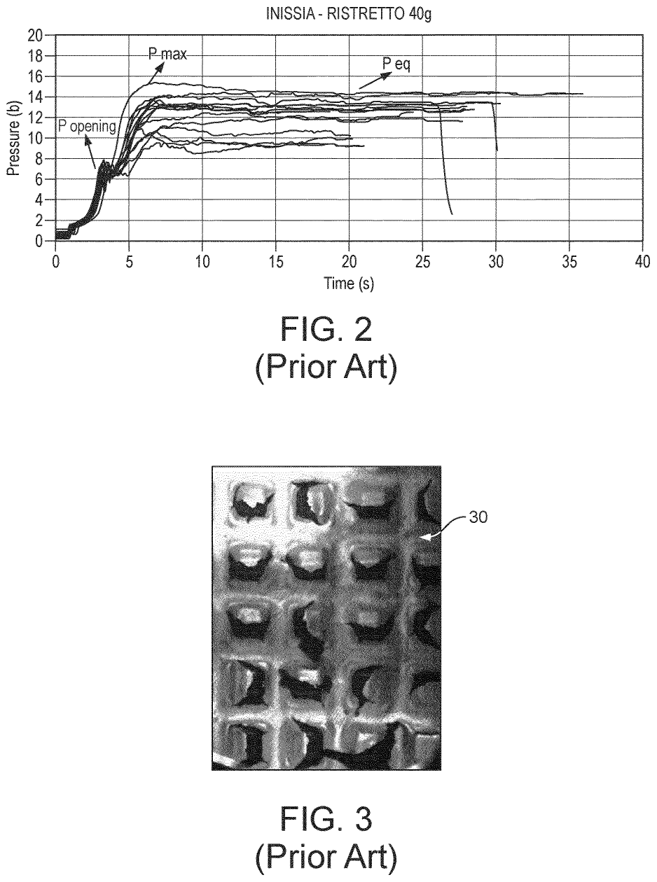

FIG. 2 presents the extraction pressure curve over time of a series of aluminium capsules 2 as above described. As can be seen, the extraction pressure curves, even if following a generally similar curve, have certain variability in the maximum pressure Pmax and in the equilibrium pressure Peq. Pmax may vary between 9 and 15 bars and Peq at 20 seconds, similarly as at 15 seconds, may vary between 9 and 14 bars. The opening of the capsule generally happens between 3 and 5 seconds after the injection of the water in the capsule and the opening pressure Popening is comprised between 6 and 8 bars.

FIG. 3 show the aluminium delivery wall 30 of an aluminium capsule 2 as currently available after extraction in a Nespresso® beverage preparation machine as presented in FIGS. 1A and 1B. As can be seen, the opening of the delivery wall 30 and hence of the capsule 2 occurs through material deformation of the delivery wall 30 and consequent tearing against the pyramidal elements 1122 of the extraction plate 1120 of the extraction chamber 11. The openings are visible to the naked eye and allow a clear understanding of how the capsule works and how the coffee is extracted.

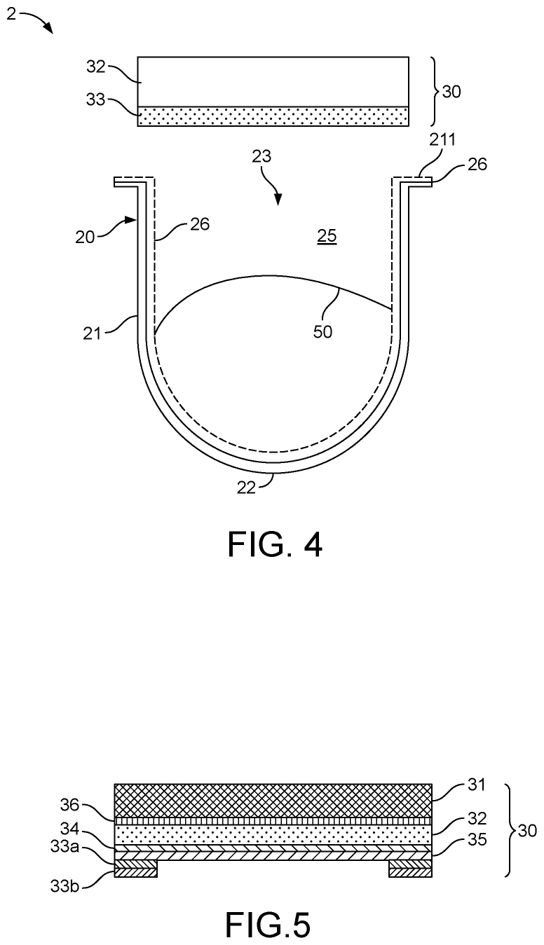

FIG. 4 shows a schematic exploded view of a capsule made of biodegradable, preferably compostable material to be used in the claimed system and FIG. 5 shows in schematic cross-section a possible structure of the delivery wall of the capsule used in the system of the proposed invention.

The elements of the capsule 2 already presented in connection with the disclosure of FIG. 1A will have the same references.

The main difference between the capsule 2 of FIG. 1A and the capsule 2 of FIG. 4 is that the capsule 2 of FIG. 4 is made of biodegradable preferably compostable material.

The compostable capsule 2 of FIG. 4 may have a composite structure and/or may be made from a composite material, which preferably may consist entirely of biodegradable and/or compostable materials.

The capsule 2 comprises a capsule body 20 with a three-dimensional shape with a sidewall 21. The capsule body 20 may have any shape or form, for example the capsule body may be in the form of a cup-shaped body. For example, the capsule body 20 may have a form that is suitable for the capsule 2 being inserted in the extraction chamber (or module) 11 of a (known) beverage production machine, for example a Nespresso® beverage production machine as disclosed in connection with FIGS. 1A and 1B. The capsule body 20 may have a truncated-, cup-or bowl-shaped form. The capsule body 20 may have a circular cross-section. Thereby, for example, pressure related forces exerting on the capsule body 20 can be absorbed.

The capsule body 20 comprises a sidewall 21. The sidewall 210 delimits a chamber 25 inside the capsule 2. The sidewall 21 may be provided such that it encloses a continuous space inside the capsule body 20.

The chamber 25 is arranged to receive and store a substance 50 for the preparation of the beverage. Therein, the substance 50 may be any type of (solid, liquid, at least partially soluble and/or percolate-able) matter of a particular or definite chemical constitution. Examples for substances 50 may be roasted ground coffee, instant coffee, tealeaves, syrup concentrate, fruit extract concentrate, a chocolate product, dehydrated edible substances, and/or combinations thereof. Accordingly, examples for beverages that may be prepared may be coffee-or chocolate-based drinks, or other similar types of food. However, the above examples for the substance 500 and beverages are not to be seen as a complete enumeration. Instead, various other examples are conceivable.

The capsule body 20 may have an opening 23 to the chamber 25. The opening 23 may be on at least one of the capsule body's 20 opposite ends. For example, the substance 50 may be filled inside the capsule 2 through the opening 23. Preferably, a rim portion 211 of the sidewall 210 may delimit the opening 23. The rim portion 211 may have the form of a flange and extend from the sidewall 21, preferably away from the chamber 25. In operation, the capsule 2 may be placed on the rim portion 211 inside a capsule holder of a beverage production machine. The sidewall 21 may be provided such that it forms a continuous mantle surface of the capsule body 20. For example, the sidewall 21 may have an inside surface facing the chamber 25 and an outside surface facing away from the chamber 25.

A protective layer 26, also called liner, for providing a preferably bidirectional barrier against moisture and/or oxygen for the substance 50 may be provided on the capsule body 20 and/or the sidewall 21. In FIG. 1, the protective layer 26 is exemplarily illustrated as being provided as a liner on the inside surface of the sidewall 21, which may extend up to and over the rim portion 211. The protective layer 26 may be provided additionally or alternatively on the outside surface of the sidewall 21. Additionally, or alternatively, the protective layer may be provided as a coating having similar barrier properties. Therein, the protective layer 26 may be made of a biodegradable and preferably compostable material, such as biopolymers or bioplastic families such as PHB and co-polymers, PBS, PBS-A, PLA, PBAT, Cellulose Acetate, starch, PVOH, and it may include any polymers or co-polymers where at least one of the monomer units is vinyl alcohol (for example BVOH, Butenediol vinyl alcohol), as well as compounds or laminates of any of the above-mentioned materials. Preferably, the protective layer 26 may be made of a food safe material (FCS, FCMs).

For example, the capsule body 20 may be made of (laminated) (wet/dry) moulded pulp fibre. Preferably, the capsule body 20 may be made of a biodegradable and/or compostable material. The capsule body 20 may be made of a food safe material (FCS, FCMs). The capsule body 20 may comprise a layered and/or laminated structure. For example, the capsule body 20 may be relatively stiff or rigid so not to collapse during operation in a beverage production machine or during storage. The layered and/or laminated design may provide the capsule body 20 with additional rigidity and/or stiffness in comparison to other designs. Therein, the moulded pulp fibre may be a composite having an additional substrate, such as biodegradable resin, laminated on the capsule body 20. For example, a laminated structure of the capsule body 20 may be created by providing the protective layer 26 thereon. However, it is also conceivable that the capsule body 20 may comprise, for example, in addition to the protective layer 26 a further laminate film or layer.

Alternatively, the capsule body 20 may be made of paper-based material or of a paper-based material with a laminate, specifically shaped to delimit a chamber 25.

The capsule 2 comprises an injection wall 22 for injecting a fluid in the chamber 25 for preparing the beverage upon interaction of the fluid with the substance 50. This is exemplarily illustrated in FIG. 4.

The injection wall 22 may be provided on an opposite end of the capsule body 20 to the opening 23. The injection wall 22 may be provided integrally or separately with the capsule body 20. Hence, the capsule body 20 and the injection wall 22 may be made up of separate pieces or may be integrally formed as a one-piece. The injection wall 22 may form a tapered end portion of the capsule body 20. The injection wall 22 may be configured to be perforated by blades of the coffee production machine such that the blades provide openings for the fluid injection. Preferably, the fluid may be a liquid or a liquid/gas mixture, such as water or milk. As the capsule body 20, the injection wall 22 may comprise also the above-described protective layer 26. It is also conceivable, that the injection wall 22 may comprise (small) openings through which blades of the coffee production machine can enter and pierce the protective layer 26. Like the capsule body 20, the injection wall 22 may comprise a layered and/or laminated structure and may be made of (laminated) moulded pulp fibre and/or a food safe material (FCS, FCMs).

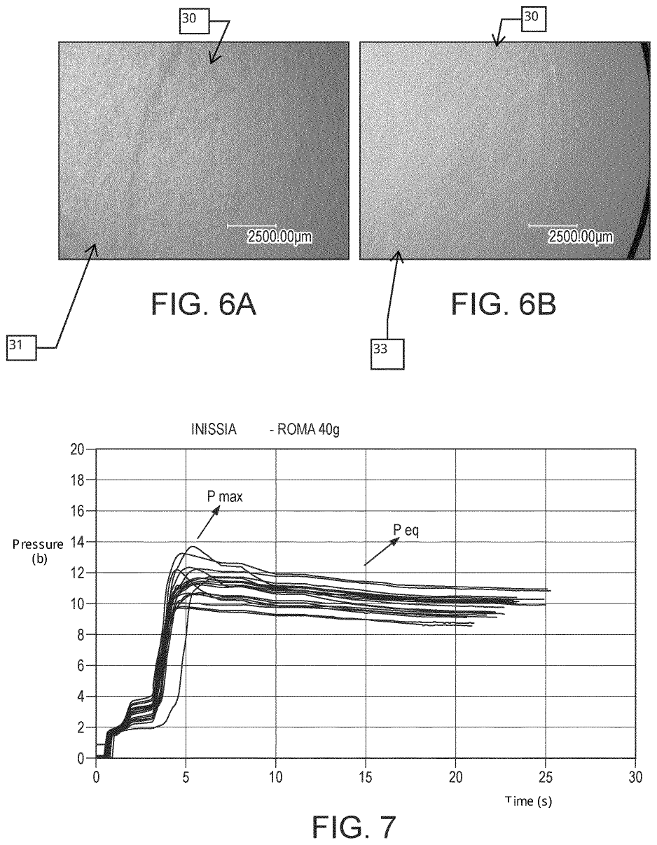

The capsule body 20 and the injection wall 22 may be provided such that the chamber 25 is closed (sealed) preferably from at least three sides as shown in FIG. 6. The capsule body 20 and the injection wall 22 may be provided such that the injected fluid is dispersed evenly in the chamber 25 along the sidewall 21.

Within the disclosure of FIG. 4, the capsule 2 comprises a delivery wall 30, which is connected to the capsule body 20 to close the chamber 25.

The delivery wall 30 is provided in a layered manner as exemplarily shown in FIGS. 4 and 5. There is no limitation on the number of (different) layers the delivery wall 30 may have. The delivery wall 30 is flat. The word “flat” shall mean that the delivery wall 30 extends substantially in one plane. In other words, the delivery wall 30 extends in one plane, but it can be deformed in a convex or concave plane, depending on the relative pressure between the inside and the outside of the capsule. In particular, it can happen that the ingredient contained therein (e.g., roast and ground coffee) will produce gases such as carbon dioxide over the storage period of the pod. In this case, an overpressure can be created within the capsule, which forces the—initially flat—delivery wall to bulge outside. It can also happen that the atmospheric pressure varies around the capsule, for instance if the capsule is formed, filled and sealed at a factory which is near sea level, and then said capsule is transported at a higher altitude, where the atmospheric pressure is lower. In such case, the—initially flat—delivery will deflect inwardly in a concave shape.

As presented in FIG. 4, the delivery wall comprises
a carrier layer 32 being adapted to be opened under the effect of rising pressure of the fluid being injected into the capsule, and
an adhesive layer 33 provided on the side of the carrier layer 32 that is oriented towards the chamber 25 for joining the delivery wall 30 to the rim portion 211 of the capsule body 20.

The carrier layer 32 and the adhesive layer 33 are both made of biodegradable material and are presently made of different material.

The carrier layer 32 is made of biodegradable material. Preferably, the carrier layer 32 may be made of a material that is compostable and/or a food safe material (FCS, FCMs) also. Additionally, or alternatively, the (material of the) carrier layer 320 may have a defined fibre structure, such as a closed fibre structure. For example, the carrier layer 320 material may be a fibre structure with at least 50% of weight corresponding to softwood pulp. Further examples for the material of the carrier layer 320 may be one or any combination of the group of cellulose fibres, paper, biopolyesters, PHA, PHB and co-polymers, PBS, PBS-A, PVOH and/or polymers where at least one of the monomer units is vinyl alcohol.

In the present case, the carrier layer 32 may be a paper or a supercalendered paper, having closed pores allowing keeping pressure inside the capsule during extraction.

The carrier layer 32 is adapted to be opened under the effect of rising pressure of the fluid being injected in the capsule 2 during extraction in the beverage preparation machine. The carrier layer 32 may be a film, membrane or ply with a defined thickness and preferably with a substantially planar surface.

The carrier layer 32 may be provided such that it is resilient against a built-up pressure in the chamber 25, preferably between 1 and 20 bar, more preferred between 10 and 20 bar, most preferred between 12 and 18 bar. In particular, the material of the carrier layer 32 may be configured such that it is resilient against a built-up pressure in the chamber 25 within such pressure ranges. Therein, the thickness and density of the material may influence the stiffness, i.e., the resistance to a bend, of the carrier layer 32. The carrier layer 32 may have a thickness of material of 10 to 150 micrometers, preferably 30 to 70 micrometers. Alternatively, or additionally, the carrier layer 32 may have a grammage between 20 and 150 g/m2, preferably between 40 and 100 g/m2. Preferably, the carrier layer 32 may be attached to the (rim portion 211) capsule body 20, preferably by heat-sealing or adhesive bonding.

As mentioned, the delivery wall 30 also comprises an adhesive layer 33 for adhesion of the delivery wall 30 to the capsule body 20. As mentioned, and as a one-piece element, the delivery wall 30 may be connected to the rim portion 211 of the capsule body 200 to close the chamber 25, thereby forming a closed capsule 2. This may be accomplished, for example, by heat-sealing or adhesive connection.

Therefore, in the present proposed embodiment, the adhesive layer 33 may be provided between the carrier layer 32 of the delivery wall 30 and the capsule body 20, with which (adhesive layer) the capsule body 200 and the delivery wall 300 may be attached (joined) to each other.

More precisely and as represented in FIG. 4, the adhesive layer 33 is provided on the carrier layer 32.

The adhesive layer 33 may comprise of one or more adhesive layers 33a, 33b . . . , (as shown in FIG. 5) and may be integrated in the delivery wall 300, especially if integrated into a laminated structure.

The total thickness of the adhesive layer 33, applied in one or more layers 33a, 30b, is between 1 and 30 micrometers, preferably between 10 and 15 micrometers. In the proposed embodiment, the thickness is around 10 to 13 micrometers.

The material forming of the adhesive layer may be a biodegradable (and preferably compostable) material, such as vegetable based starch or acrylic adhesive. In the present embodiment the adhesive layer 330 is a polymer made of acrylic adhesive.

From the above description, the adhesive layer 33 is hence made of a different material than the carrier layer 32.

This material of the adhesive layer is preferably hydrophobic.

Additionally, the selected material is non-hydrosoluble to avoid any interaction with/degradation by the moisture content of the beverage substance 50 which may be, for example, roast and ground coffee.

This material is applied, as previously mentioned, in one or more layers. The total amount of adhesive material applied on the perimeter of the carrier layer is comprised between 0.5 and 20 gsm. This ensures that sufficient adhesive material is applied on the carrier layer 32 for an efficient tight sealing of delivery wall 30 on the rim portion 211 of the capsule body 20.

The one or more adhesive layer may be applied as coating, for example, a water-based coating.

In addition to the carrier layer 32 and to the adhesive layer 33 already disclosed, the delivery wall 30 may further comprise any one of a filter layer 31, a barrier layer 34, a bonding layer 36, and a protective layer 35.

FIG. 5 presents in schematic cross-section, a second embodiment of the capsule's delivery wall of the capsule of FIG. 6 that may be used in the system according to the proposed invention.

The delivery wall 33 of FIG. 5 comprises a filter layer 31, a bonding layer 36, a carrier layer 32, a barrier layer 34, a protective layer 35 and an adhesive layer 33.

The main characteristics of the carrier layer 32 and of the adhesive layer 33 have already been described in connection with FIG. 4 and may present the same characteristics and properties when integrated in the delivery wall 30 of FIG. 5.

The filter layer 31 mentioned in connection with FIG. 5 is provided opposite to the chamber 25 with respect to the carrier layer 32. This particular order and orientation of the carrier layer and the filter layer with respect to the capsule body leads to a number of improvements. For example, it is observed that the pressure profile during the beverage preparation is more consistent and reproducible. Moreover, a better crema formation and extraction and a reduced concentration of particles and residues of the substance, e.g. roast and ground of coffee, is found with this configuration in the beverage. The specific position of the filter also allows a softer opening and prevents back cracking.

Resulting from the above, the carrier layer may face the chamber or may be provided closer to the chamber than the filter layer. Therein, for example, the expression “facing” may be understood as being directed towards the respective reference object without necessarily having to be provided directly onto the respective reference object.

The filter layer 31 is made of a compostable and/or non-woven material, such as wood or sugarcane pulp, cellulose fibres, rayon fibres, polybutylene succinate (PBS), poly(butylene succinate-co-butylene adipate) (PBS-A/PBSa), polyhydroxybutyrate (PHB) and/or Polylactic acid (PLA).

The filter layer 31 has a total grammage between 10 and 150 g/m2, preferably between 20 and 100 g/m2 which ensures efficient filtering of any particle of the substance enclosed in the capsule chamber, for example roast and ground coffee.

Thereby, the characteristics of the filter layer can be set by defining their area density of material, i.e. as mass per unit of area. For example, the tensile strength of the filter layer can be improved by increasing the grammage of its material and/or by using a (non-woven) material comprising fibres of a defined length and/or with a defined fibre bonding. Moreover, the filtration capacity and/or the porosity of the filter layer can be modified, e.g. reduced to smaller particle diameters, by setting the filter layer's material characteristics accordingly. Thereby, it is possible to tailor the filter layer to the specific requirements of the

The barrier layer 34 which is integrated in the proposed delivery wall's structure is applied on the surface of the carrier layer facing the chamber of the capsule body.

The barrier layer 34 is preferably made of a biodegradable and preferably compostable material, such as biopolymers, polyvinyl alcohol (PVOH), Butenediol vinyl alcohol copolymer (BVOH), or any vinyl alcohol co-polymers where at least one of the monomer units is vinyl alcohol, and compounds or laminates of the above-mentioned materials.

Preferably, the barrier layer is made of a different material than the filter layer and/or the carrier layer. This allows benefitting from the different material properties of both the filter layer and the carrier layer.

Hence, with the proposed delivery wall structure comprising the filter layer, the carrier layer and the barrier layer made from the previously proposed material, the Oxygen Transmission Rate (OTR) of the delivery wall (300) is below 35 cc/m2/day, measured according to ASTM D3985/ISO 15105 methodology.

The addition of the mentioned protective layer 35 may further improve the characteristics of the delivery wall. The protective layer 35 extends on the surface of the barrier layer facing the chamber of the capsule, for the protection of the barrier layer. It is thereby possible to guarantee that the barrier layer is fully protected.

The protective layer is applied in one or more protective layers in a total amount of 0.1 to 5 gsm (g/m2), preferably between 2 and 3.5 gsm (g/m2) and with a maximum total thickness of 5 microns.

The protective layer is made of a biodegradable and preferably compostable material, such as a vegetable-based starch or acrylic adhesive polymers.

Furthermore, the protective layer is preferably non hydrosoluble to avoid its degradation by the moisture content of the substance enclosed in the chamber. The protective layer is preferably made of a different material than the filter layer and/or the carrier layer to ensure proper separation of the physicochemical properties of the different layers

As mentioned, and shown in FIG. 5, the bonding layer 36 is interposed between the carrier layer 32 and the filter layer 31 to join them through adhesive bonding or heat-sealing. Hence, the carrier layer 32 and the filter layer 31 are at least partially joined to each other on opposite sides thereof, i.e. on their sides facing each other thanks to the bonding layer 36.

The bonding layer 36 is made of one or more bonding layers and provides adhesive bonding between the carrier layer 32 and the filter layer 31 to ensure efficient adhesion of the two above-mentioned layers.

The bonding layer is also of a biodegradable and preferably compostable material, such as vegetable based starch or acrylic adhesive and participate to the biodegradable properties of the complete capsule.

Bonding strength of the bonding layer 36 may vary depending on the material of the filter layer 31 and carrier layer 32.

As can be also seen in FIG. 5, the adhesive layer 33 does not cover the full surface of the delivery wall 30. The adhesive layer has a limited radial extension (starting from the periphery of the delivery wall) and extends solely on the periphery of the carrier layer, all around its perimeter. The extension of the adhesive layer 33 on the perimeter of the carrier layer 32 over at least a radial distance D.

The radial distance D has to be at least equal, preferably a bit bigger than the radial extension of the rim portion 211 on which the delivery wall 30 is sealed. In the proposed embodiment of FIG. 4, the radial distance D of extension of the adhesive layer is comprised between 3 mm and 12 mm, preferably between 5 to 10 mm, so that a proper sealing of the periphery of the carrier layer on the rim portion 211 is provided.

In the proposed disclosure, the adhesive layer 33 clearly covers less than 50% of the surface of the carrier layer 32.

As shown in FIG. 5, the (one or more) adhesive layer 33 is only applied on the periphery of the carrier layer 32, all around its perimeter over a radial distance D of about 7 mm. This radial distance D may vary between 3 and 12 mm, however, it is preferably limited in extension to a value that is slightly more than the rim portion radial extension. As exemplified, there is no adhesive layer at the center of the carrier layer to enable easier opening of delivery wall 30 and interaction with the opening elements of a beverage production machine for improved control of the extraction parameters.

The surface of the carrier layer 32 covered by the adhesive layer 33 may be limited to the periphery of the delivery wall with an extension of a radial distance D from the perimeter edge of the carrier layer 320 of the delivery wall 30. However, other valuable configurations may be implemented.

In the proposed embodiments, the adhesive layer is a heat-sealing layer 33 that can be sealed on the rim portion 211 by local heat application. The sealing of the delivery wall 30 on the rim portion of the capsule 2 is done all around the perimeter of the delivery wall.

As mentioned, preferably, each of the filter layer, the barrier layer and the carrier layer is made of a different biodegradable and preferably compostable material, wherein preferably the different materials distinguish in at least one of their respective physical properties, such as tensile strength, ductility, elasticity, puncture resistance, density, porosity, and/or, if applicable, fibre structure and/or fibre orientation.

FIGS. 6A and 6B are both showing an enlarged view of the capsule's delivery wall of FIG. 5 comprising the described layered structure, respectively viewed from the side of the filter layer 31 from the side of the adhesive layer 33, prior to the extraction of the capsule 2. The enlargements are obtained using an optical microscope, for instance a Keyence VHX-7000. The enlargement scale is represented on the figures themselves.

FIG. 6A shows the delivery wall 30 on the filter layer 31 side. As can be seen, the surface's aspect is granular and rough. This is due to the material selected for the filter layer, which, in the present case is a cellulose-based filter.

FIG. 6B shows the delivery wall 30 on the adhesive layer 33 side. As can be seen, the surface's aspect is smooth and glossy. This is due to the material selected for the adhesive layer, which, in the present case is an acrylic adhesive.

Both layers do not have any visible holes or openings at the presented scale.

FIG. 7 represents an extraction curve (Pressure over time) of a series of pulp molded compostable capsules like the one of FIG. 4 comprising the delivery wall of FIG. 5, extracted in a Nespresso® Inissia machine. As can be seen, the extraction curves have very similar shape and a narrow extension of the curves showing a reduced variability in the extraction curves. it is observed that the extraction pressure profile during the beverage preparation is more consistent and reproducible with the compostable capsules.

The maximum pressure Pmax may vary between 9 and 14 bars, however, a maximum number of the curves have a Pmax varying between 10 and 12 bars.

The values of equilibrium pressure Peq at 15 seconds of the different curves is also narrower and ranges between 9 and 12 bars.

From the extraction curves of FIG. 7, the opening of the capsule is not visible as in the curves of FIG. 2 where it is happening as a pressure drop as presented in FIG. 2 (see Popening in FIG. 2).

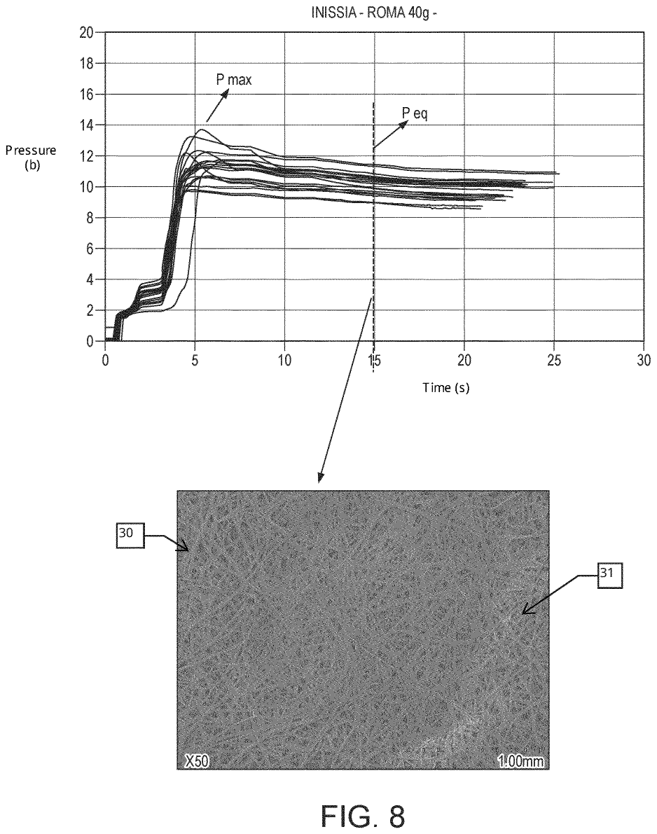

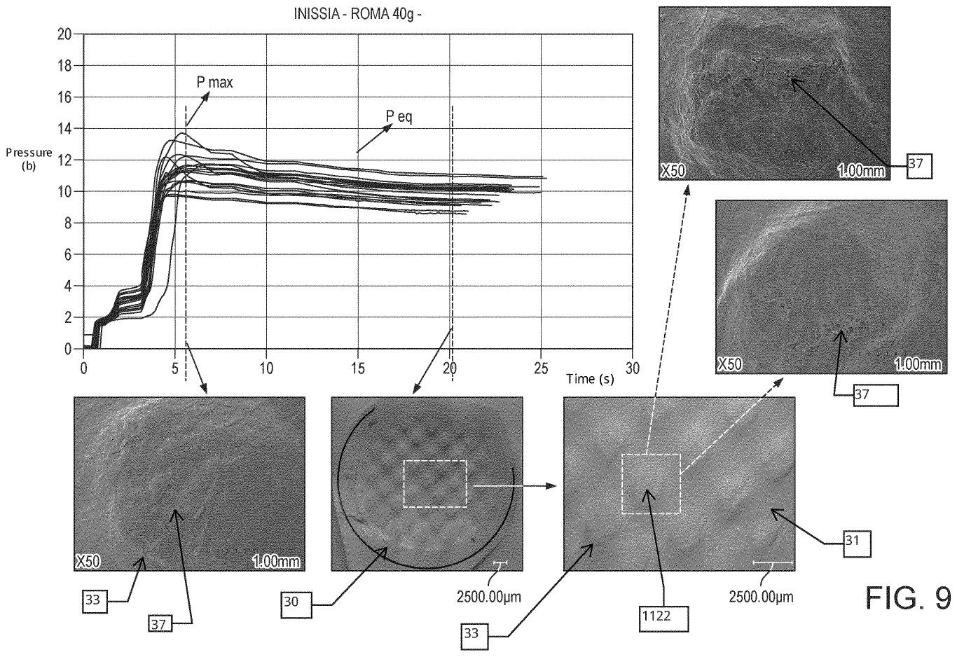

In the proposed compostable capsules, the opening is more progressive and follows a different process as the one of Aluminium capsules. This process will be described in connection with FIGS. 8 and 9.

FIG. 8 shows an enlarged view of the delivery wall 30 viewed from the side of the filter layer 31 after extraction at Peq (15 seconds) of one of the capsules presented in the extraction curve of FIG. 7 (above reproduced in the Figure).

This enlarged view of the filter layer 31 was obtained by scanning electron microscope (SEM), specifically a Hitachi FlexSEM.

As can be seen, the fibers of the filter layer 31 are homogeneously stretched so as to allow a liquid to flow trough. The spacing that occurs between the filter fibers following the interaction of the delivery wall with the pyramidal elements, results in an opening of the filter layer for the coffee beverage to be drained.

FIG. 9 shows a series of enlarged views at different scales of the delivery wall 30 viewed from the side of the adhesive layer 33 at two extraction times of one of the capsules presented in the curve of FIG. 7.

From the extraction curves, a first enlargement taken at Pmax is proposed and presented on left side of the figure. This enlargement is a SEM enlargement (×50).

This image is taken at the beginning of the extraction (here between 5 and 6 seconds after the start of the extraction); the delivery wall has deformed against the pyramidal elements 1122 assuming the shape of the truncated top end portions of the pyramidal elements of the extraction plate 1120 further to the injection of water and pressure rising inside the capsule. As can be seen, even if the delivery wall is deformed against the pyramidal elements there is no material tearing, rupture or failure. Tiny holes corresponding to permeable openings 37 may be seen in the adhesive layer 33.

At 20 seconds from the start of the extraction, corresponding to the end of the extraction when the equilibrium pressure Peq is achieved (meaning when the coffee is being drained/has been drained out of the capsule), two images using optical microscope are presented below the extraction curves.

The first image shows the delivery wall 30 (seen from the adhesive layer 33 side) that has assumed the pyramidal elements shape. The pattern of the pyramidal elements of the extraction plate of the beverage preparation machine is particularly visible.

The second image, directly on the right, is an enlarged view of the selected rectangular zone of the preceding described image. The enlargement values/scales are presented in each image. In this image, similarly to the preceding described image, the delivery wall assumed the pyramidal elements shape without any visible material tearing, rupture or failure. The pyramidal elements pattern of the extraction plate is particularly visible and applied on the delivery wall 30.

The last two remaining images of FIG. 9 (setting on the right side of the extraction curves) are further enlarged views of one selected zone of the previously described image and correspond to the deformation of the delivery wall on one single pyramidal element. These two images are made on different location of the deformed delivery wall 30, specifically, on the top-end portion of the pyramidal element. As visible on these two images, some holes (bigger than the ones present on the delivery wall at Pmax) corresponding to permeable openings 37 are distributed along certain lines in the adhesive material. The permeable openings 37 are mainly located proximate the top portions of the truncated pyramidal elements.

The size of the holes is ranging from 100 μm2 to 4000 μm2 (0.0001 mm 2 to 0.0040 mm2 ). These permeable openings 37 are of sizes allowing the coffee beverage to be drained outside of the capsule.

It should be emphasized that similarly as the previously disclosed images and figures, the holes forming the permeable openings 37 are not resulting from any material tearing or rupture. Hence, on the contrary to what is happening during the aluminium capsules opening, the opening of the delivery wall as visible from the adhesive layer side in the proposed compostable capsule is not obtained through tearing, breaking or rupturing of the delivery wall but though a permeable opening by formation of porous cavities following both the interaction of the delivery wall with the pyramidal elements and with the pressurized water inside the capsule.

As such, within the system of the invention, the pyramidal elements 1122 of the extraction plate are designed so as to present truncated pyramidal top end portions, and the delivery wall 30 of the capsule:
is stretched by the pyramidal elements 1122, preferably by the truncated pyramidal top end portions of the pyramidal elements, in the first step of the beverage preparation, and
becomes permeable by formation of cavities leading to permeable openings 37 without any tearing effect, in the second step of the beverage preparation.

It should be understood that various changes and modifications to the presently preferred embodiments of the capsules described herein will be apparent to those skilled in the art. Such changes and modifications can be made without departing from the scope of the present invention covered by the appended claims.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

Unless otherwise explicitly stated as incompatible, or the physics or otherwise of the embodiments, example or claims prevent such a combination, the features of the foregoing embodiments and examples, and of the following claims may be integrated together in any suitable arrangement, especially ones where there is a beneficial effect in doing so. This is not limited to only any specified benefit, and instead may arise from an “ex post facto” benefit. This is to say that the combination of features is not limited by the described forms, particularly the form (e.g. numbering) of the example(s), embodiment(s), or dependency of the claim(s). Moreover, this also applies to the phrase “in one embodiment”, “according to an embodiment” and the like, which are merely a stylistic form of wording and are not to be construed as limiting the following features to a separate embodiment to all other instances of the same or similar wording. This is to say, a reference to ‘an’, ‘one’ or ‘some’ embodiment(s) may be a reference to any one or more, and/or all embodiments, or combination(s) thereof, disclosed. Also, similarly, the reference to “the” embodiment may not be limited to the immediately preceding embodiment.

The foregoing description of one or more implementations provides illustration and description but is not intended to be exhaustive or to limit the scope of the invention to the precise form disclosed. Modifications and variations are possible in light of the above teachings or may be acquired from practice of various implementations of the present disclosure.

1. A system comprising a beverage preparation machine and a capsule, the capsule containing a beverage ingredient,
wherein the capsule comprises
a capsule body with a three-dimension shape comprising a sidewall delimiting a chamber for containing the beverage ingredient, and the capsule body further comprising a rim portion delimiting an opening in the sidewall,
an injection wall for injecting a fluid in the chamber for preparing a beverage upon interaction of the fluid with the beverage ingredient and
a delivery wall connected to the capsule body to close the chamber, the delivery wall comprising biodegradable materials and comprising in a layered manner at least:
a carrier layer adapted to be opened under rising pressure of the fluid injected into the capsule and
an adhesive layer on a side of the carrier layer that is oriented towards the chamber for joining, the delivery wall onto the rim portion of the capsule body,
and
wherein the beverage preparation machine comprises an extraction device for extracting the beverage from the capsule and the extraction device comprises:
upstream and downstream capsule enclosing parts relatively movable between an open position for inserting and/or ejecting the capsule and a closed position for forming an extraction chamber enclosing the capsule during extraction,
the upstream capsule enclosing part comprising:
an upstream piercing arrangement for opening the injection wall of the capsule and
a fluid injector,
the downstream capsule enclosing part comprising an extraction plate configured for engaging with the capsule, the extraction plate comprising pyramidal elements facing, in use, the delivery wall of the capsule,
and
wherein, during preparation of the beverage, the extraction device is configured:
in a first step of the preparation of the beverage, to enclose the capsule between the upstream and downstream capsule enclosing parts and then,
in a second step of the preparation of the beverage, to introduce the fluid inside the capsule through the fluid injector,
wherein the pyramidal elements of the downstream part and the delivery wall of the capsule are designed so that
in a first step of interaction of the pyramidal elements with the delivery wall, the delivery wall interacts with the pyramidal elements and assumes an imprint of the pyramidal elements on a surface of the delivery wall, the surface facing the pyramidal elements, without visible piercing of the delivery wall,
in a second step of interaction of the pyramidal elements with the delivery wall, upon contact of the fluid injected in the capsule with the surface of the delivery wall facing the chamber of the capsule, permeable openings appear in of the delivery wall through cavities in one or more layers of the delivery wall, and
during a third step of interaction of the pyramidal elements with the delivery wall, the beverage is drained from the capsule and contacts the extraction plate.

2. The system according to claim 1, wherein the pyramidal elements of the extraction plate and the delivery wall of the capsule are designed so that, during the first step of interaction of the pyramidal elements with the delivery wall, the pyramidal elements do not pierce or tear the delivery wall during their relative engagement under the rise in pressure of the fluid injected in the capsule and inflation of the delivery wall against the pyramidal elements after the pressure inside the capsule reaches at least 6 bars.

3. The system according to claim 1, wherein the delivery wall of the capsule starts opening after the pressure inside the capsule reaches at least 8 bars.

4. The system according to claim 1, wherein the carrier layer comprises paper-based material that is compostable.

5. The system according to claim 1, wherein the carrier layer comprises paper-based material and has a grammage between 20 and 150 g/m2.

6. The system according to claim 1, wherein the delivery wall further comprises a filter layer for filtering particles from the beverage dispensed via the delivery wall the filter layer provided opposite to the chamber with respect to the carrier layer.

7. The system according to claim 6, wherein the filter layer comprises a compostable and/or non-woven material that is different from the carrier layer, and/or wherein the filter layer has a grammage between 10 and 150 g/m 2.

8. The system according to claim 1, wherein the delivery wall further comprises a barrier layer for providing a barrier against moisture and/or gas; the barrier layer applied on the side of the carrier layer facing the chamber, between the carrier layer and the adhesive layer.

9. The system according to claim 8, wherein the barrier layer comprises a biodegradable material.

10. The system according to claim 1, wherein the pyramidal elements of the extraction plate comprise truncated pyramidal top end portions, and wherein the delivery wall of the capsule:
is stretched by the pyramidal elements, end in the first step of the preparation of the beverage, and
becomes permeable by formation of the cavities without any tearing, in the second step of the preparation of the beverage.

11. The system according to claim 10, wherein the cavities formed in the delivery wall of the capsule are mainly located proximate the top portions of the truncated pyramidal elements.

12. The system according to claim 1, wherein most of the openings in the delivery wall have a size ranging from 0.0001 mm2 to 0.0040 mm2.

13. The system according to claim 1, wherein the extraction device is configured so that when the upstream and downstream capsule enclosing parts are moving one to the other to enclose the capsule in the extraction chamber, at least a part of the extraction device pushes the capsule so that the delivery wall of the capsule faces the extraction plate of the downstream enclosing part.

14. The system according to claim 1, wherein in the extraction device:
the upstream capsule enclosing part defines a cage designed to enclose the capsule body and bears an upstream piercing arrangement for opening a bottom wall of the capsule, and
the downstream capsule enclosing part defines a capsule holder positioned transverse to a closing direction of the extraction device, the capsule holder comprising an extraction plate interacting with the delivery wall of the capsule during extraction of the beverage.

15. (canceled)

16. The system according to claim 1, wherein the beverage ingredient is roast and ground coffee.

17. The system according to claim 1, wherein the adhesive layer heat-seals the delivery wall onto the rim portion of the capsule body.

18. The system according to claim 4, wherein the material of the carrier layer that is compostable comprises at least 50% of weight that is softwood pulp, cellulose fiber, paper, Polyhydroxyalkanoate (PHA), Polyhydroxybutyrate (PHB) and co-polymers, Polybutylenesuccinate (PBS/PBS-A), biopolyesters, Cellulose Acetate, starch, polyvinyl alcohol (PVOH), polymers where at least one of the monomer units is vinyl alcohol, compounds thereof, laminates thereof, or any mixture thereof.

19. The system according to claim 5, wherein the grammage of the carrier layer is between 30 and 100 g/m2 .

20. The system according to claim 7, wherein the compostable and/or non-woven material of the filter layer comprises one or more of wood pulp, sugarcane pulp, cellulose fibres, rayon fibres, polybutylene succinate (PBS), poly(butylene succinate-co-butylene adipate) (PBS-A/PBSa), polyhydroxybutyrate (PHB), Polylactic acid (PLA), or any mixture thereof.

21. A method of preparation of a beverage from a beverage ingredient contained by a capsule, wherein the capsule comprises a capsule body with a three-dimension shape comprising a sidewall delimiting a chamber for containing the beverage ingredient, and the capsule body further comprising a rim portion delimiting an opening in the sidewall, the method comprising:
injecting a fluid through an injection wall of the capsule, into the chamber to prepare the beverage upon interaction of the fluid with the beverage ingredient, wherein the capsule further comprises a delivery wall connected to the capsule body to close the chamber, the delivery wall comprising a biodegradable material and comprising in a layered manner at least (i) a carrier layer and (ii) an adhesive layer on a side of the carrier layer that is oriented towards the chamber for joining the delivery wall onto the rim portion of the capsule body;
opening the carrier layer under rising pressure of the fluid injected into the capsule, wherein the beverage preparation machine comprises an extraction device for extracting the beverage from the capsule;
relatively moving upstream and downstream capsule enclosing parts of the extraction device between an open position for inserting and/or ejecting the capsule and a closed position for forming an extraction chamber enclosing the capsule during extraction;
opening the injection wall of the capsule, wherein an upstream piercing arrangement of the upstream capsule enclosing part opens the injection wall of the capsule, wherein the upstream capsule enclosing part further comprises a fluid injector;
engaging an extraction plate of the downstream capsule enclosing part with the capsule, the extraction plate comprising pyramidal elements facing, in use, the delivery wall of the capsule,
wherein, during the preparation of the beverage, the extraction device encloses the capsule between the upstream and downstream capsule enclosing parts and then introduces the fluid inside the capsule through the fluid injector;
interacting the delivery wall with the pyramidal elements, wherein the delivery wall assumes an imprint of the pyramidal elements on a surface of the delivery wall, the surface facing the pyramidal elements, without visible piercing of the delivery wall;
upon contact of the fluid injected in the capsule with the surface of the delivery wall facing the chamber of the capsule, forming permeable openings in the delivery wall through cavities in one or more layers of the delivery wall; and
draining the beverage from the capsule, wherein the beverage contacts the extraction plate.
